(19) United States
(12) Patent Application Publication
(10) Pub. No.: US 2019/0164326 A1
(43) Pub. Date: May 30, 2019

(54) GROUPING CONTROL METHOD, STORAGE MEDIUM, AND INFORMATION SHARING SYSTEM

(71) Applicant: FUJITSU LIMITED, Kawasaki-shi (JP)

(72) Inventor: Koki Hatada, Kawasaki (JP)

(73) Assignee: FUJITSU LIMITED, Kawasaki-shi (JP)

(21) Appl. No.: 16/202,035

(22) Filed: Nov. 27, 2018

(30) Foreign Application Priority Data
Nov. 28, 2017 (JP) 2017-228072

(51) Int. Cl. G06T 11/60; G06K 9/00; G06K 9/62

(52) U.S. Cl. CPC G06T 11/60; G06K 9/6215; G06K 9/00436

(57) ABSTRACT

A grouping control method to be executed by a computer, the grouping control method includes, based on a positional relation between a first object and a second object, displaying a third object associated with the second object and determining whether or not the first object and the second object are to be grouped together based on a degree of approximation between the first object and the third object.

### CROSS-REFERENCE TO RELATED APPLICATION

This application is based upon and claims the benefit of priority of the prior Japanese Patent Application No. 2017-228072, filed on Nov. 28, 2017, the entire contents of which are incorporated herein by reference.

### FIELD

The embodiments discussed herein are related to a grouping control method, a storage medium, and an information sharing system.

### BACKGROUND

A system designed to display a shared screen for sharing display elements such as characters, figures, images (hereinafter collectively referred to as objects) and the like among users has been known in recent years. For example, this system allows the users to write various objects on the shared screen, to move display positions of the objects on the shared screen, to conduct grouping of the objects on the shared screen, and to do the like.

Related techniques are disclosed in, for example, Japanese Laid-open Patent Publication Nos. 2015-49773 and 2010-218443.

### SUMMARY

According to an aspect of the embodiments, a grouping control method to be executed by a computer, the grouping control method includes, based on a positional relation between a first object and a second object, displaying a third object associated with the second object and determining whether or not the first object and the second object are to be grouped together based on a degree of approximation between the first object and the third object.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a system configuration example of an information sharing system of a first embodiment;

FIGS. 2A to 2C are diagrams to explain an outline of object grouping of the first embodiment;

FIG. 3 is a diagram illustrating a hardware configuration example of an information processing device of the first embodiment;

FIG. 4 is a diagram to explain a functional configuration of a grouping control unit of the first embodiment;

FIG. 5 is a first diagram to explain positions of guides of the first embodiment;

FIGS. 6A and 6B are second diagrams to explain positions of the guides of the first embodiment;

FIG. 7 is a diagram illustrating an example of an object information table of the first embodiment;

FIG. 8 is a diagram illustrating an example of a group information table of the first embodiment;

FIG. 9 is a flowchart to explain processing by the grouping control unit of the first embodiment;

FIGS. 10A and 10B are first diagrams to explain the grouping of the first embodiment;

FIGS. 11A and 11B are second diagrams to explain the grouping of the first embodiment;

FIG. 12 is a diagram to explain a functional configuration of a grouping control unit of a second embodiment;

FIG. 13 is a diagram to explain a change in size of an object of the second embodiment;

FIGS. 14A and 14B are diagrams to explain changes in display position of an object of the second embodiment;

FIGS. 15A and 15B are diagrams to explain ungrouping of objects of the second embodiment;

FIGS. 16A and 16B are first flowcharts to explain processing by the grouping control unit of the second embodiment; and

FIG. 17 is a second flowchart to explain the processing by the grouping control unit of the second embodiment.

### DESCRIPTION OF EMBODIMENTS

When a system in existence conducts grouping of objects, the system conducts an operation to superimpose the objects on each other, an operation to select a mode to conduct the grouping, and the like. However, when the objects are superimposed on each other, objects that are not intended for grouping may be superimposed on each other and thus grouped together due to an erroneous operation or the like. In addition, an operation is complicated in the case of selecting the mode to conduct the grouping.

An object of an aspect of this disclosure is to achieve grouping of objects easily.

### First Embodiment

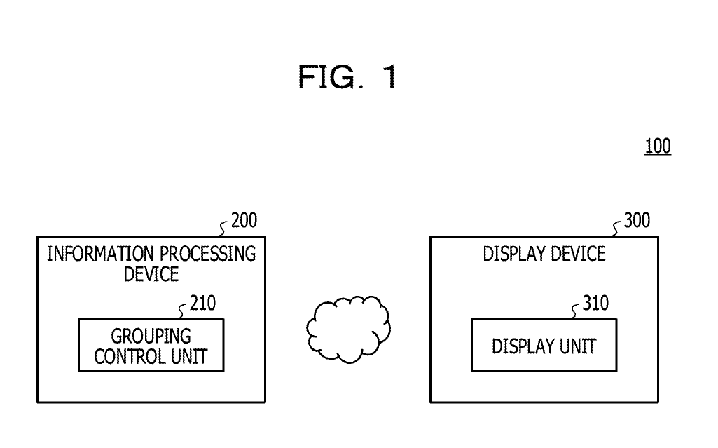

A first embodiment is described below with reference to the drawings. FIG. 1 is a diagram illustrating a system configuration example of an information sharing system of the first embodiment.

An information sharing system 100 of this embodiment includes an information processing device 200 and a display device 300.

In the information sharing system 100 of this embodiment, the information processing device 200 is connected to the display device 300 through a network or the like. Regarding the information sharing system 100, a method of connection between the information processing device 200 and the display device 300 may either be wired or wireless.

The information processing device 200 of this embodiment causes the display device 300 to display a shared screen to be shared by multiple users. To put it another way, the display device 300 includes a display unit 310 that displays the shared screen based on information outputted from the information processing device 200.

The shared screen in this embodiment is a screen that enables the multiple users to write or move display elements such as characters, figures, and images (hereinafter collectively referred to as objects), for example. In the following description, the shared screen is simply referred to as a screen.

Operations concerning these objects may be conducted by using, for example, a terminal device connected to the information processing device 200. When the display device 300 is equipped with a touch panel and the like, the operations concerning the objects may be conducted by using the display device 300. When the display device 300 is a projection device that projects an operation screen on a projection screen and the like while the information processing device 200 has a function to detect a gesture of a user near the projection screen, the operations concerning the objects may be conducted on the projected operation screen.

The information processing device 200 of this embodiment includes a grouping control unit 210, which puts multiple objects displayed on the screen into one group in response to an operation concerning the objects displayed on the display device 300. To put it another way, the grouping control unit 210 conducts grouping of the objects displayed on the screen.

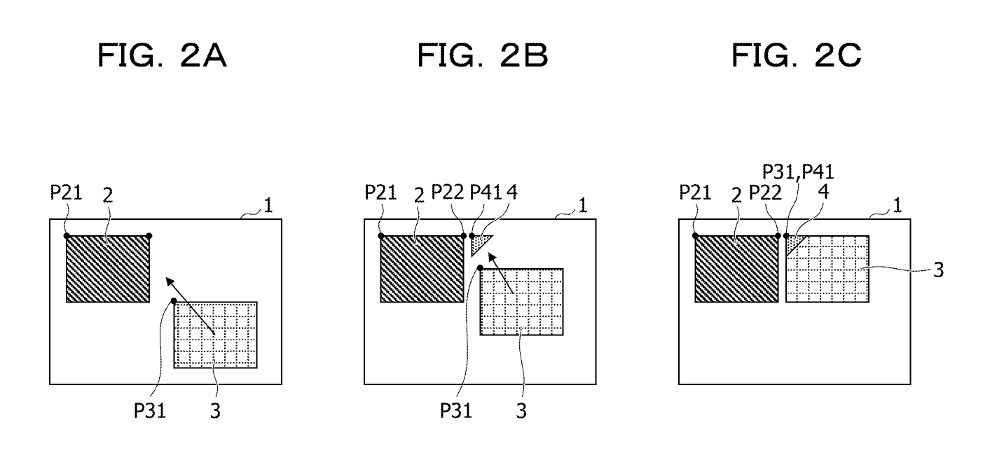

The object grouping by the grouping control unit 210 of this embodiment is described below with reference to FIGS. 2A to 2C.

FIGS. 2A to 2C are diagrams to explain an outline of the object grouping of the first embodiment. FIG. 2A illustrates a first state of an object 2 and an object 3 displayed on a screen 1, FIG. 2B illustrates a second state of the object 2 and the object 3 displayed on the screen 1, and FIG. 2C illustrates a third state of the object 2 and the object 3 displayed on the screen 1. In the example of FIGS. 2A to 2C, each object represents an image of a rectangular region.

The first state in FIG. 2A illustrates a state in which the object 3 on the screen 1 is dragged and moved toward the object 2 in order to group the object 3 and the object 2 together.

Here, the grouping control unit 210 detects the object 3 that comes close to the object 2 based on a movement direction and a movement distance of a peak P31 on the upper left of the object 3, for example, and then identifies the object 2 as a candidate for an object to be put into the same group as the object 3.

For instance, the grouping control unit 210 may identify the object 2 as the candidate when a distance between a peak P21 on the upper left of the object 2 and the peak P31 is equal to or below a first predetermined value, for example. Although FIGS. 2A to 2C illustrate the example in which each object is a rectangular image and the distance between the objects on the screen 1 is acquired based on the coordinates of the peaks on the upper left of the respective objects. However, the distance between the objects is not limited to this example. For instance, the center point of each object may be defined as a reference point and a distance between the center points may be acquired instead. The distance between the objects may be acquired as a distance between such reference points on the premise that the reference point is thus defined in each object.

When the object 2 is identified as the candidate, the grouping control unit 210 displays a guide 4 for grouping at a position around the object 2 and facing the object 3 in a traveling direction (the movement direction) as illustrated in FIG. 2B. Though the guide 4 is depicted as a triangular image (an object) in FIG. 2B, the shape of the guide is not limited to this shape. For example, the guide 4 may be formed into a circular shape or into a mark in the shape of a star or the like.

On the screen 1, the object 3 is displayed on the lower right of the object 2 and is moving closer to the object 2 from the lower right of the object 2. Accordingly, the grouping control unit 210 displays the guide (the object) 4 at a position near a peak P22 of the object 2, which is located around the object 2 and faces the object 3 in the traveling direction.

In this case, a peak P41 of the guide 4 is displayed such that a distance between the peak P41 and the peak P22 is equal to or below the first predetermined value. Note that the guide 4 may be displayed such that the peak P41 is superimposed on the peak P22.

Then, as the object 3 comes even closer to the object 2 and the peak P31 of the object 3 is moved closer to the guide 4, the grouping control unit 210 identifies the object 2 as the object to be put into the same group as the object 3. To put it another way, the grouping control unit 210 groups the object 2 and the object 3 together.

For instance, the grouping control unit 210 groups the object 3 and the object 2 together when a distance between the peak P31 and the peak P41 is equal to or below a second predetermined value. Although the distance between the guide 4 and the object 3 is calculated in this embodiment by defining the peak P41 as the reference point, the reference point of the guide 4 does not have to be the peak P41. The reference point of the guide 4 may be set to any point as long as such a point is available for calculation of the distance between the object and the guide.

Then, the grouping control unit 210 moves the object 3 such that the peak P41 of the guide 4 is superimposed on the peak P31 of the object 3, and displays the object 3 near the object 2. Here, as illustrated in FIG. 2C, the grouping control unit 210 superimposes and displays the guide 4 on the object 3. The above-described way of displaying the guide 4 allows a user to visually confirm that the object 2 and the object 3 are grouped together.

Each of the first predetermined value and the second predetermined value may be a value preset depending on the size and other factors of the screen 1, for example. Here, the first predetermined value is a larger value than the second predetermined value. The first predetermined value is a threshold for the distance between the objects for identifying the object serving as the candidate for the grouping. The second predetermined value is a threshold for the distance between the guide and object used for determining whether or not it is appropriate to conduct the grouping.

As described above, in this embodiment, the third object (the guide) associated with the second object is displayed based on the positional relation between the first object and the second object, and the first and second objects are grouped together based on the approximation of the third object to the first object.

Accordingly, this embodiment does not require an operation to superimpose the objects, an operation to select a mode to conduct the grouping, and the like. Thus, the objects may be grouped together easily with a simple operation.

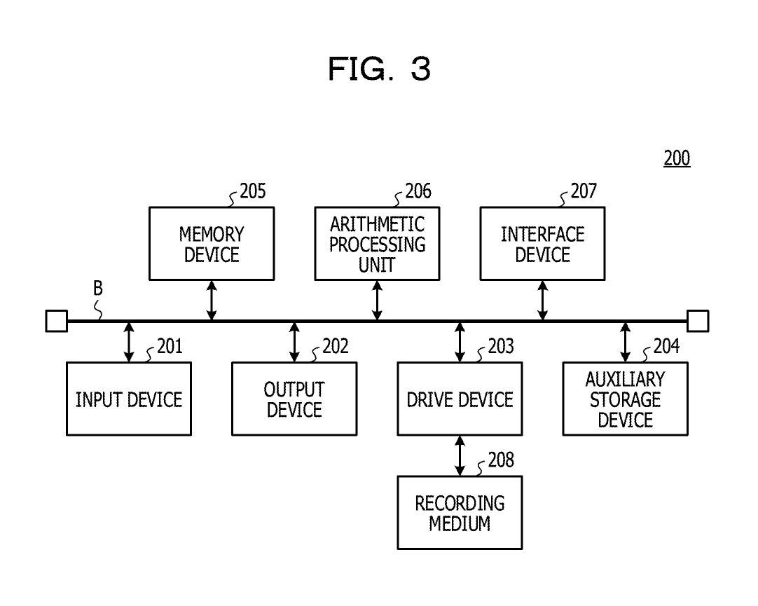

The information processing device 200 of this embodiment is described below in further detail. FIG. 3 is a diagram illustrating a hardware configuration example of the information processing device of the first embodiment. The information processing device 200 of this embodiment realizes the functions of the grouping control unit 210 by using the hardware configuration illustrated in FIG. 3.

The information processing device 200 of this embodiment is an information processing device that includes an input device 201, an output device 202, a drive device 203, an auxiliary storage device 204, a memory device 205, an arithmetic processing unit 206, and an interface device 207, which are connected to one another through a bus B.

The input device 201 is a device used for inputting a variety of information and is realized, for instance, by using a keyboard, a pointing device, and the like. The output device 202 is used for outputting a variety of information and is realized, for instance, by using a display unit and the like. The interface device 207 includes a LAN card and the like, and is used for establishing connection to a network.

A grouping program constitutes at least part of various programs that control the information processing device 200. The grouping program is provided, for example, by distributing a storage medium 208, being downloaded from the network, and the like. The storage medium 208 recorded with the grouping program may apply various types of recording media including: a storage medium used for recording the information optically, electrically, or magnetically such as a CD-ROM, a flexible disk, and a magneto-optical disk; a semiconductor memory used for recording the information electrically such as a ROM and a flash memory; and the like.

When the storage medium 208 recorded with the grouping program is set on the drive device 203, the grouping program in the storage medium 208 is installed on the auxiliary storage device 204 through the drive device 203. The grouping program downloaded from the network is installed on the auxiliary storage device 204 through the interface device 207.

The auxiliary storage device 204 stores the installed grouping program and also stores required files and data. At the time of startup of the information processing device 200, the memory device 205 reads the grouping program out of the auxiliary storage device 204 and stores the grouping program in itself. Then, the arithmetic processing unit 206 realizes a variety of processing to be described later in accordance with the grouping program stored in the memory device 205. For example, the information processing device 200 may be a tablet-type terminal device, a smartphone, or the like. In the meantime, a display-operating device realized by using a touch panel and the like may be provided instead of the input device 201 and the output device 202.

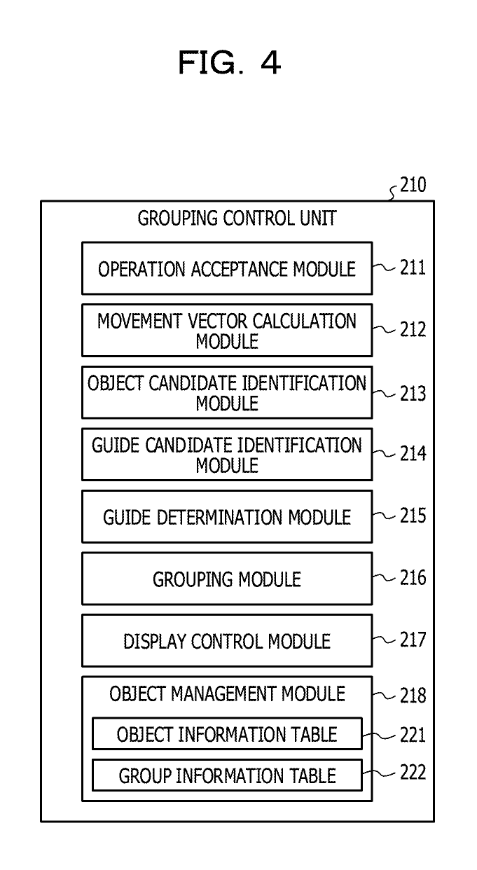

Next, functions of the grouping control unit 210 of this embodiment are described with reference to FIG. 4. FIG. 4 is a diagram to explain the functions of the grouping control unit of the first embodiment.

The grouping control unit 210 of this embodiment includes an operation acceptance module 211, a movement vector calculation module 212, an object candidate identification module 213, a guide candidate identification module 214, a guide determination module 215, a grouping module 216, a display control module 217, and an object management module 218.

The operation acceptance module 211 accepts an operation concerning one of the objects displayed on the display device 300. The movement vector calculation module 212 calculates a movement direction and a movement distance of the object when the operation accepted by the operation acceptance module 211 is an operation to move the object.

The object candidate identification module 213 identifies a candidate for an object to be put into the same group based on the movement direction of the movement distance of the aforementioned object calculated by the movement vector calculation module 212. For instance, the object candidate identification module 213 identifies an object, which is located at a distance equal to or below the first predetermined value toward the movement direction of the object for which the operation is accepted, as the candidate for the object.

The guide candidate identification module 214 identifies candidates for a guide to be displayed for the object that is identified as the candidate by the object candidate identification module 213. The guide determination module 215 determines the guide to be displayed out of the candidates for the guide identified by the guide candidate identification module 214. Details of processing to be conducted by the guide candidate identification module 214 and the guide determination module 215 are described later.

The guide to be displayed mentioned herein is the guide for grouping the objects together, or the guide used for the determination as to whether or not it is appropriate to conduct the grouping.

When the distance between the reference point of the guide determined by the guide determination module 215 and the reference point of the object for which the operation is accepted is equal to or below the second predetermined value, the guide, the object associated with the guide, and the object for which the operation is accepted are grouped together by the grouping module 216.

The display control module 217 controls the display on the screen to be displayed on the display device 300 depending on the operation concerning the object accepted by the operation acceptance module 211, the determination of the guide by the guide determination module 215, and the like. To put it another way, the display control module 217 is an output module which outputs data to the display device 300 so as to display the screen tailored to the processing by the grouping control unit 210.

The object management module 218 manages information concerning the objects displayed on the screen and information concerning the grouped objects.

For instance, the object management module 218 includes an object information table 221 and a group information table 222. The object information table 221 manages the information concerning the objects displayed on the screen. The group information table 222 manages the information concerning the grouped objects. Details of the object information table 221 and the group information table 222 are described later.

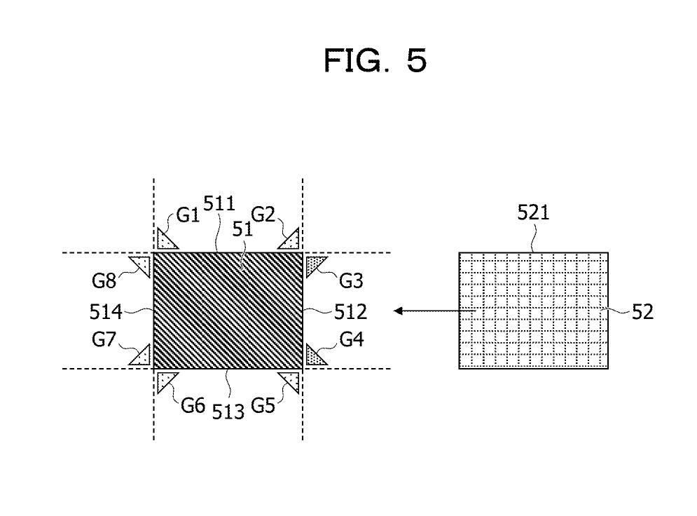

Next, processing by the guide candidate identification module 214 and the guide determination module 215 of this embodiment is described with reference to FIG. 5. FIG. 5 is a first diagram to explain positions of the guides of the first embodiment.

An object 51 illustrated in FIG. 5 is a rectangular image. In this embodiment, when the object is a rectangle, the guides associated with this object are displayed on two ends of each side of the object.

As a consequence, regarding the object 51, positions where it is possible to display the guides are two ends of each of sides 511, 512, 513, and 514. In FIG. 5, the guides to be displayed on two ends of the side 511 are indicated as guides G1 and G2, the guides to be displayed on two ends of the side 512 are indicated as guides G3 and G4, the guides to be displayed on two ends of the side 513 are indicated as guides G5 and G6, and the guides to be displayed on two ends of the side 514 are indicated as guides G7 and G8. In the following description, the guides to be displayed around the object are referred to as guides (objects) associated with the object.

Now, let us assume that the operation acceptance module 211 accepts an operation to drag and move an object 52 closer to the object 51. In this case, when the distance between the object 52 and the object 51 is equal to or below the first predetermined value, the object 51 is identified as the candidate for the object to be put into the same group as the object 52.

When the object 51 is identified, the guide candidate identification module 214 identifies the guides G1 to G8 associated with the object 51 as the candidates for the guides to be displayed. In the example of FIG. 5, the side 512 is the side of the object 51, which faces the object 52 in the traveling direction.

Regarding the object 52 in this case, a side 521 of the object 52 is collinear with the side 511 of the object 51 and the movement direction of the object 52 is horizontal with respect to the object 51. As a consequence, the guide determination module 215 determines the guides G3 and G4 located on the two ends of the side 512 as the guides to be displayed out of the guides G1 to G8 being the candidates for the guides to be displayed.

As described above, the guide candidate identification module 214 of this embodiment identifies the guides associated with the object identified as the candidate for the grouping as the candidates used for determination of the appropriateness of the grouping. The guide determination module 215 of this embodiment determines the guides that face the object in motion in the traveling direction out of the candidates for the guides, as the guides used for the determination of the appropriateness of the grouping.

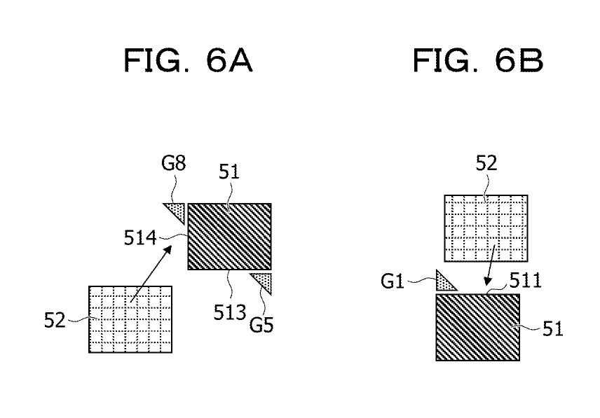

FIGS. 6A and 6B are second diagrams to explain the positions of the guides of the first embodiment. FIG. 6A illustrates an example of displaying two guides out of the guides associated with the object 51, while FIG. 6B illustrates an example of displaying one guide out of the guides associated with the object 51.

In FIG. 6A, the object 52 is displayed on the lower left of the object 51, and comes closer to the object 51 from the lower left thereof.

Accordingly, the guide determination module 215 determines the side 513 and the side 514 of the object 51 as the sides facing the object 52 in the traveling direction.

In this instance, the guide determination module 215 selects the guide G8 out of the guides on the two ends of the side 514 as the guide possibly located ahead of the movement direction of the object 52, and determines the guide G8 as the guide to be displayed. In this case, the guide determination module 215 also selects the guide G5 out of the guides on the two ends of the side 513 as the guide possibly located ahead of the movement direction of the object 52, and determines the guide G5 as the guide to be displayed. For instance, the guide determination module 215 determines the guide G5 as the guide used for determining whether or not it is appropriate to group the object 51 and the object 52 together.

In the example of FIG. 6A, the guide determination module 215 displays the two guides. However, the operation of the guide determination module 215 is not limited to the foregoing. The guide determination module 215 may display just the guide G8 located ahead of the movement direction of the object 52, for example.

In FIG. 6B, the object 52 is displayed on the upper right of the object 51, and moves to the lower left so as to come close to the object 51.

Accordingly, the guide determination module 215 displays the guide G1 located ahead of the movement direction of the object 52, out of the guide G1 and the guide G2 on the two ends of the side 511 facing the traveling direction of the object 52.

As described above, the guide determination module 215 of this embodiment determines the guide located ahead of the movement direction of the object for which the operation is accepted as the guide to be displayed out of the guides identified as the candidates to be displayed.

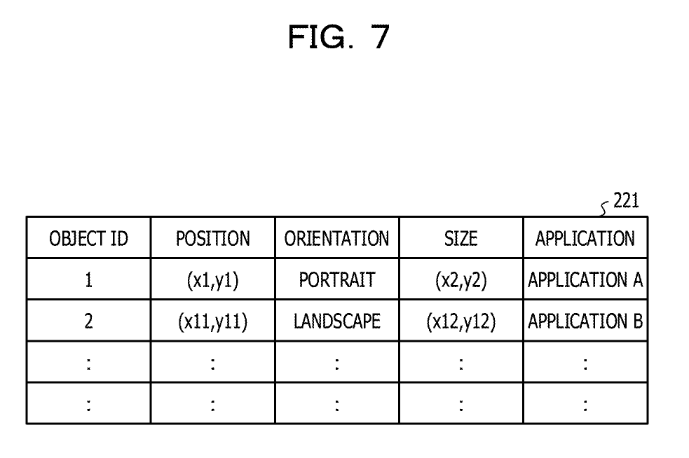

Next, the object information table 221 of this embodiment is described with reference to FIG. 7. FIG. 7 is a diagram illustrating an example of the object information table of the first embodiment.

The object information table 221 of this embodiment includes the following information items, namely, object ID, position, orientation, size, and application. Here, the item “object ID” is associated with the rest of the items. In the following explanation, information including a value of the item “object ID” and other values is referred to as object information.

In this embodiment, every time an object is displayed on the display device 300 the object management module 218 stores the object information on the displayed object in the object information table 221. The object management module 218 may delete the object information on the object from the object information table 221 after termination of the display thereof.

Accordingly, the object information table 221 stores the object information on the object displayed on the screen of the display device 300.

The value of the item “object ID” represents identification information for identifying the object. The values of the item “position” represent coordinate information indicating the position on the screen where the object is displayed. The values of the item “position” of this embodiment may instead be information indicating the position of the reference point of the object on the screen.

The value of the item “orientation” represents an orientation of the object on the screen. To put it another way, the value of the item “orientation” indicates whether the object on the screen is turned or not.

The values of the item “size” represent the size of the object on the screen. For example, these values represent the size of a display region of the object relative to a display region of the screen. In this embodiment, the values of the item “size” may instead be indicated as coordinates of a point satisfying a certain positional relation with the coordinates of the reference point that represents the item “position”, for instance.

For example, when the reference point of the object is defined as the peak on the upper left in the case of the object having the rectangular shape, the values of the item “size” may be indicated as the coordinates of the peak on the lower right of the object.

The value of the item “application” represents information to identify an application that displays the object. The application that displays the object may be a sticky note application, for example.

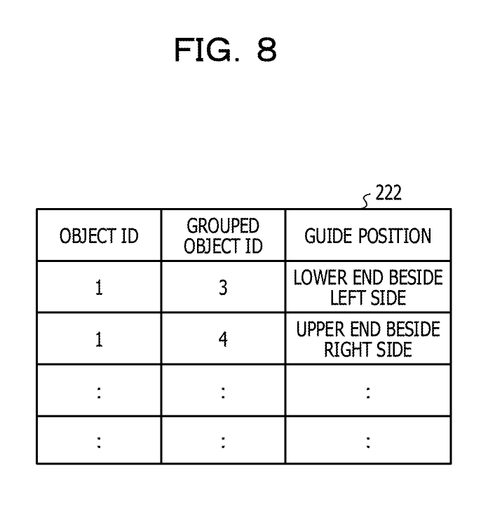

Next, the group information table 222 of this embodiment is described with reference to FIG. 8. FIG. 8 is a diagram illustrating an example of the group information table of the first embodiment.

The group information table 222 of this embodiment includes the following information items, namely, object ID, grouped object ID, and guide position. Here, the item “object ID” is associated with the rest of the items.

In the following explanation, information including a value of the item “object ID” and values of the rest of the items is referred to as group information. In this embodiment, every time objects are grouped together, the group information is generated and stored in the group information table 222.

The value of the item “grouped object ID” represents an object ID of an object put into the same group as the object indicated with the item “object ID”. To put it another way, the value of the item “grouped object ID” represents the object ID of the object grouped with the object indicated with the item “object ID”.

The value of the item “guide position” represents the position of the guide out of the guides associated with the object indicated with the item “object ID”, which is displayed while being superimposed on the object indicated with the item “grouped object ID”.

In the example of FIG. 8, the object having the object ID “2” is grouped with the object having the object ID “1”. It is also learned that, of the guides associated with the object having the object ID “1”, the lower guide on the left side is superimposed and displayed on the object having the object ID “2”.

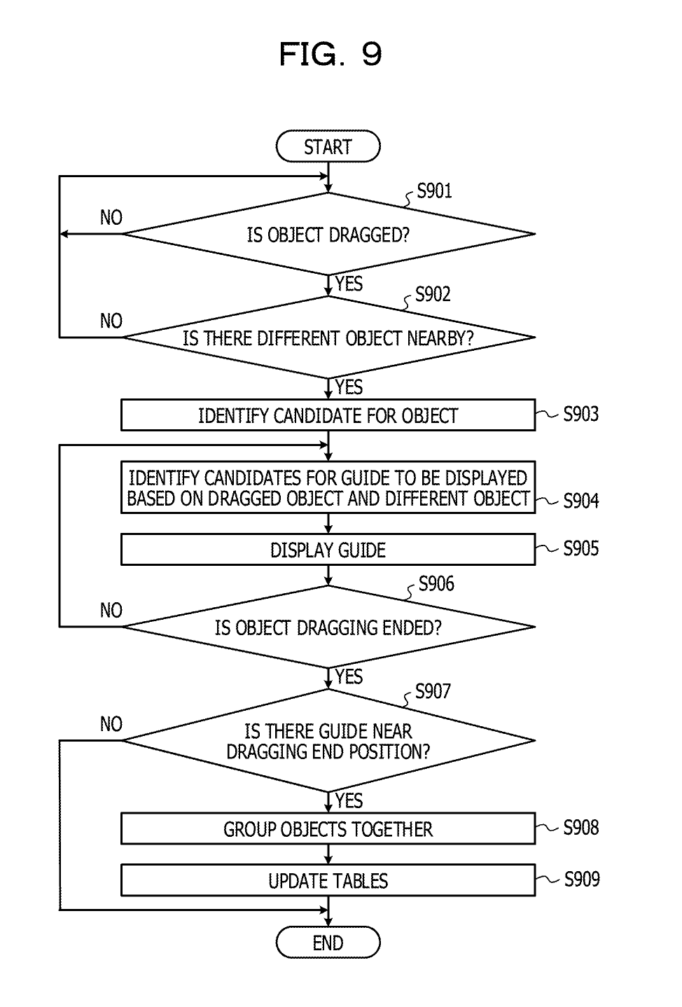

Next, processing by the grouping control unit 210 of this embodiment is described with reference to FIG. 9. FIG. 9 is a flowchart to explain the processing by the grouping control unit of the first embodiment.

The grouping control unit 210 of this embodiment causes the operation acceptance module 211 to determine whether or not the object is dragged (step S901). To put it another way, the grouping control unit 210 causes the operation acceptance module 211 to determine whether or not there is the object selected on the screen.

When there is not the applicable object in step S901, the grouping control unit 210 stands by until the objected is dragged.

When there is the applicable object in step S901, the grouping control unit 210 causes the object candidate identification module 213 to determine whether or not there is a different object from the applicable object on the screen (step S902).

For instance, the object candidate identification module 213 refers to the object information table 221 and determines whether or not the object information table 221 stores object information that is different from the object information on the selected object.

The grouping control unit 210 returns to step S901 when there is not the different object in step S902.

When there is the different object in step S902, the grouping control unit 210 causes the object candidate identification module 213 to identify the candidate for the object to be grouped (step S903).

Now, processing by the object candidate identification module 213 is described. When there is the different object, the object candidate identification module 213 of this embodiment causes the movement vector calculation module 212 to refer to the object information table 221 and to acquire the value of the item “position” included in the object information on the selected object. Next, the object candidate identification module 213 causes the movement vector calculation module 212 to compare the acquired position with the value of the item “position” included in the object information on the different object, and thus to calculate a distance between the selected object and the different object.

Then, the object candidate identification module 213 identifies the different object having the calculated distance from the different object being equal to or below the first predetermined value as the candidate for the object to be grouped. Here, the predetermined value may be set to any value depending on the size of the screen to be displayed on the display device 300, and the like.

Subsequently, the grouping control unit 210 causes the guide candidate identification module 214 to identify the candidates for the guide (step S904). For instance, the guide candidate identification module 214 identifies the guides associated with the object identified as the candidate for the grouping as the candidates for the guide to be displayed.

Then, the grouping control unit 210 causes the guide determination module 215 to determine the guide used for the determination of the grouping out of the identified candidates for the guide, and causes the display control module 217 to display the determined guide (step S905). The determination of the guide by the guide determination module 215 has been described with reference to FIGS. 5 to 6B.

Here, the guide determination module 215 may retain coordinates that indicate the position of the displayed guide. The coordinates of the guide may be defined by setting the reference point of the guide in advance and defining coordinates of the reference point of the guide as the coordinates to indicate the position of the guide.

The guide determination module 215 may define coordinates of one of the peaks of the object associated with the guide, which is located close to the guide, as the coordinates of the position of the guide.

Subsequently, the grouping control unit 210 causes the operation acceptance module 211 to determine whether or not the drag of the object is ended (step S906). The grouping control unit 210 returns to step S904 when the drag is not ended in step S906.

When the drag is ended in step S906, the grouping control unit 210 causes the grouping module 216 to determine whether or not there is the guide near the dragged object (step S907). For instance, the grouping module 216 determines whether or not the distance between the coordinates indicating the position of the dragged object and the coordinates indicating the position of the guide is equal to or below the second predetermined value.

The grouping control unit 210 terminates the processing when there is no guide near the object in step S907.

When there is the guide near the object in step S907, the grouping control unit 210 causes the grouping module 216 to group the object associated with the guide and the dragged object together (step S908). For instance, the grouping module 216 causes the display control module 217 to display the dragged object in such a way as to superimpose the guide thereon.

Accordingly, the grouping module 216 of this embodiment determines whether or not it is appropriate to group the object associated with the guide and the selected object together based on the degree of approximation between the guide and the selected object.

Then, the grouping control unit 210 causes the object management module 218 to update the object information table 221 and the group information table 222 (step S909), and then terminates the processing.

For instance, the object management module 218 changes the position of the object information on the dragged object in the object information table 221. The object management module 218 also generates group information by associating the object ID of the dragged object with the object ID of the grouped object, and stores the generated group information in the group information table 222.

As described above, in this embodiment, the operations to move the objects so as to be superimposed on each other and to switch to the mode to conduct the grouping are not required when the object is grouped with the different object. Thus, it is possible to group the objects together easily.

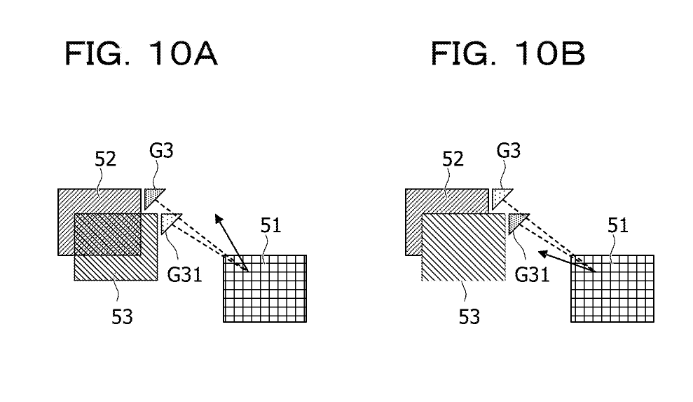

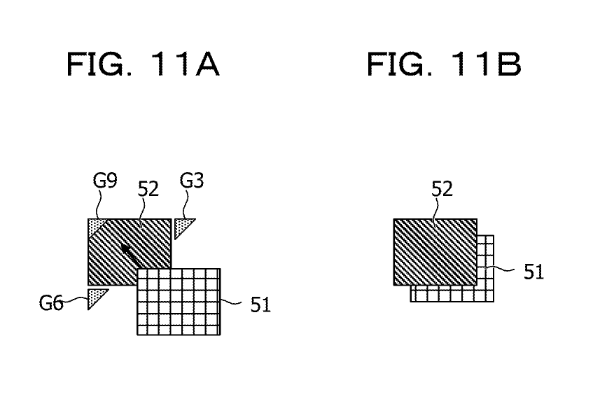

A display example when grouping the objects together is described below with reference to FIGS. 10A to 11B.

FIGS. 10A and 10B are first diagrams to explain the grouping of the first embodiment. In this embodiment, when there are multiple objects identified as the candidates for the grouping, display modes of the multiple objects and the guides associated with the respective objects are changed depending on the movement direction of the selected object.

In an example of FIG. 10A, the object 51 is selected while the object 52 and an object 53 are identified as the candidates for the grouping. In this case, the guide G3 associated with the object 52 and a guide G31 associated with the object 53 are identified as the candidates for the guide to be displayed.

In this instance, when the guide G3 is determined as the guide for the grouping based on the movement direction of the object 51 calculated by the movement vector calculation module 212, the display control module 217 of this embodiment makes the display mode of the object 52 and the guide G3 different from the display mode of the object 53 and the guide G31. For instance, the object 52 and the guide G3 are highlighted.

FIG. 10B illustrates a case where the guide G31 is determined as the guide for the grouping. In this case, the object 53 and the guide G31 are highlighted so as to be more conspicuous than the object 52 and the guide G3.

As described above, this embodiment is capable of demonstrating to the user who is conducting the operation of the object 51 how to move an object in order to group this object with another desired object.

FIGS. 11A and 11B are second diagrams to explain the grouping of the first embodiment. FIGS. 11A and 11B illustrate the example of displaying a guide on an inner side of an object.

In FIG. 11A, the object 51 is selected while the object 52 is identified as the candidate to be grouped. In this instance, since the object 51 is partially superimposed on the object 52, no guide is displayed around the lower right peak of the object 52 but the guide G3 and the guide G6 are displayed instead. In addition, a guide G9 is displayed on an inner side of the object 52 in the example of FIG. 11A.

As described above, in this embodiment, when the selected object is partially superimposed and displayed on another object, the guide may be displayed in a superimposed manner in the display region of the other object.

Moreover, in this embodiment, when the object 51 is moved closer to the guide G9, the object 51 is displayed behind the object 52. To put it another way, the object 52 is superimposed and displayed on the object 51 in this embodiment.

By displaying the objects as described above, this embodiment allows the user to visually confirm that the object 51 and the object 52 are grouped together.

Although the guide G9 is not displayed in this instance, the guide G9 may instead be displayed in the display region of the object 52.

### Second Embodiment

A second embodiment is described below with reference to the drawings. The second embodiment is different from the first embodiment in that the grouping control unit conducts ungrouping and the like. Accordingly, the following description of the second embodiment is focused on the different features from the first embodiment and the constituents having the same functional configurations are denoted by the same reference signs as those used in the first embodiment and explanations thereof are omitted.

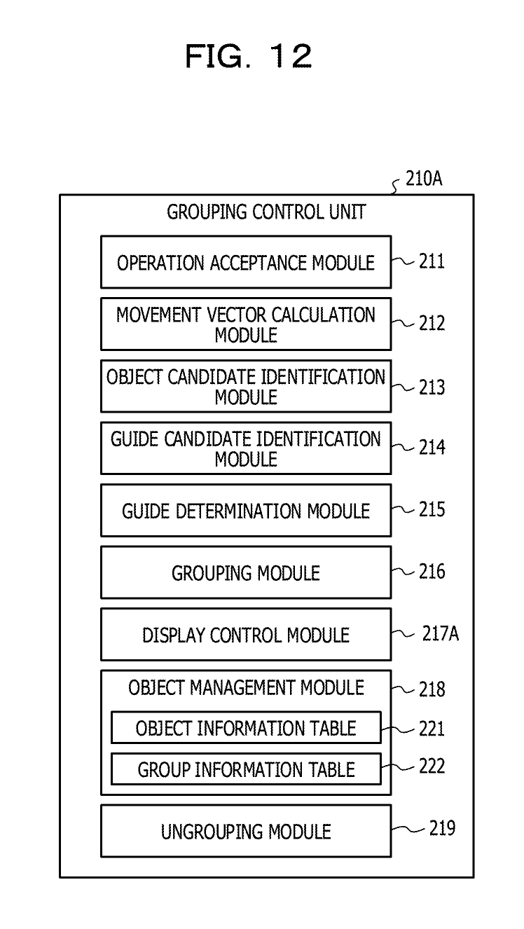

FIG. 12 is a diagram to explain a functional configuration of a grouping control unit of the second embodiment. A grouping control unit 210A of this embodiment includes the operation acceptance module 211, the movement vector calculation module 212, the object candidate identification module 213, the guide candidate identification module 214, the guide determination module 215, the grouping module 216, a display control module 217A, the object management module 218, and an ungrouping module 219.

When the operation acceptance module 211 accepts an operation to change the size of one of grouped objects, the display control module 217A of this embodiment changes the size of the object while maintaining a positional relation between the grouped objects.

In addition, when the operation acceptance module 211 accepts an operation to change a display position of one of the grouped objects, the display control module 217A changes the display position of the object subjected to the operation.

The ungrouping module 219 of this embodiment conducts ungrouping processing when the operation acceptance module 211 accepts an ungrouping operation.

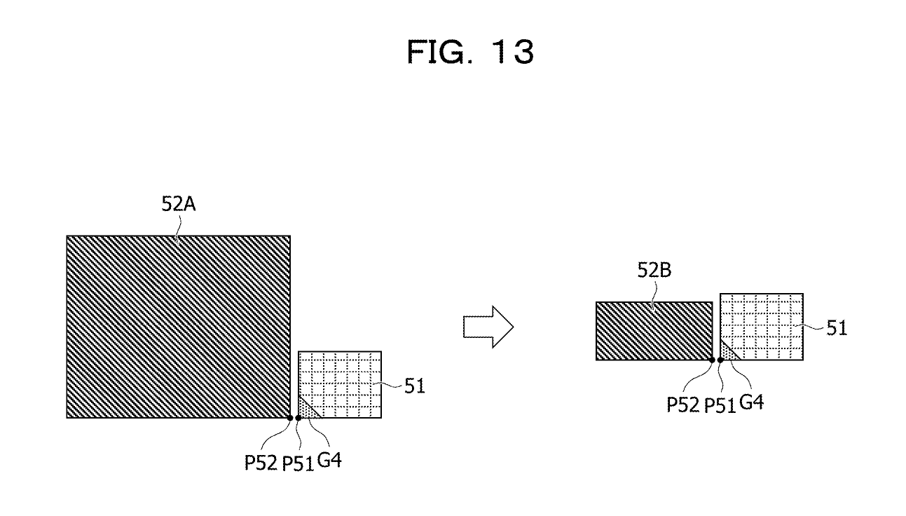

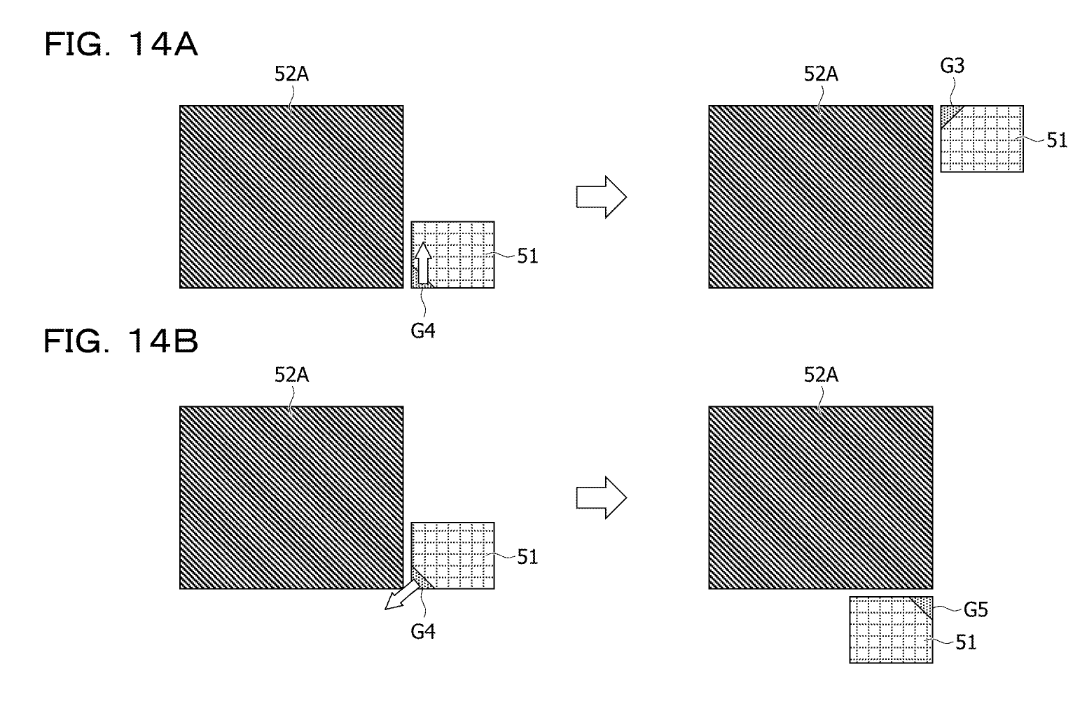

The display of the objects by the display control module 217A of this embodiment is described below with reference to FIGS. 13 to 14B.

FIG. 13 is a diagram to explain the change in size of the object of the second embodiment. In this embodiment, an object 52A and the object 51 are assumed to be grouped together where the object 52A is an image larger than the object 51.

In the example of FIG. 13, the guide G4 serving as the guide associated with the object 52A is superimposed and displayed on the object 51.

In this instance, when an operation to reduce the size of the object 52A is conducted on the object 52A, the display control module 217A reduces the size of the object 52A while maintaining a positional relation between the object 52A and the object 51.

For instance, the display control module 217A of this embodiment does not change the positional relation between the peaks of the object 52A and the object 51, each of which is located closest to the guide G4.

The peak of the object 52A located closest to the guide G4 is a peak P52, and the peak of the object 51 located closest to the guide G4 is a peak P51.

Accordingly, when the operation to reduce the size of the object 52A is accepted, the display control module 217A reduces the size of the object 52A without changing the positional relation between the peak P52 and the peak P51. To put it another way, the display control module 217A changes the size of the object 52A while maintaining the positional relation between the peak P52 and the peak P51.

The above-described maintenance of the positional relation between the grouped objects allows the user to visually confirm that the grouping is maintained.

Although FIG. 13 describes the example of reducing the size of the object 52A, the object to be changed in size may be the object 51 in this embodiment. According to this embodiment, the positional relation between the objects is maintained regardless of which one of the grouped objects is subjected to the change in size.

FIGS. 14A and 14B are diagrams to explain a change in display position of one of the objects of the second embodiment. FIG. 14A is a first diagram to explain the change in display position of the object 51 and FIG. 14B is a second diagram to explain the change in display position of the object 51.

In the example of FIGS. 14A and 14B, the object 52A and the object 51 are grouped together while the guide G4 associated with the object 52A is superimposed on the object 51.

Here, when an operation to flick the guide G4 takes place in this embodiment, for example, the display position of the object 51 is changed in response to this operation.

FIG. 14A illustrates an example of flicking the guide G4 in an upper direction. The guide G4 is hidden in this case. Meanwhile, among the guides associated with the object 52A, the guide G3 located in the upper direction of the guide G4 is displayed. Then, the grouping control unit 210A changes the display position of the object 51 to a position superimposed on the guide G3.

FIG. 14B illustrates an example of flicking the guide G4 in a lower left direction. The guide G4 is hidden in this case. Meanwhile, among the guides associated with the object 52A, the guide G5 located in the lower left direction of the guide G4 is displayed. Then, the grouping control unit 210A changes the display position of the object 51 to a position superimposed on the guide G5.

In this embodiment, the display position of the object is changed in response to the operation to flick the guide as described above. Thus, it is possible to change the display position of the object while maintaining the state of the object 52A and the object 51 being grouped together.

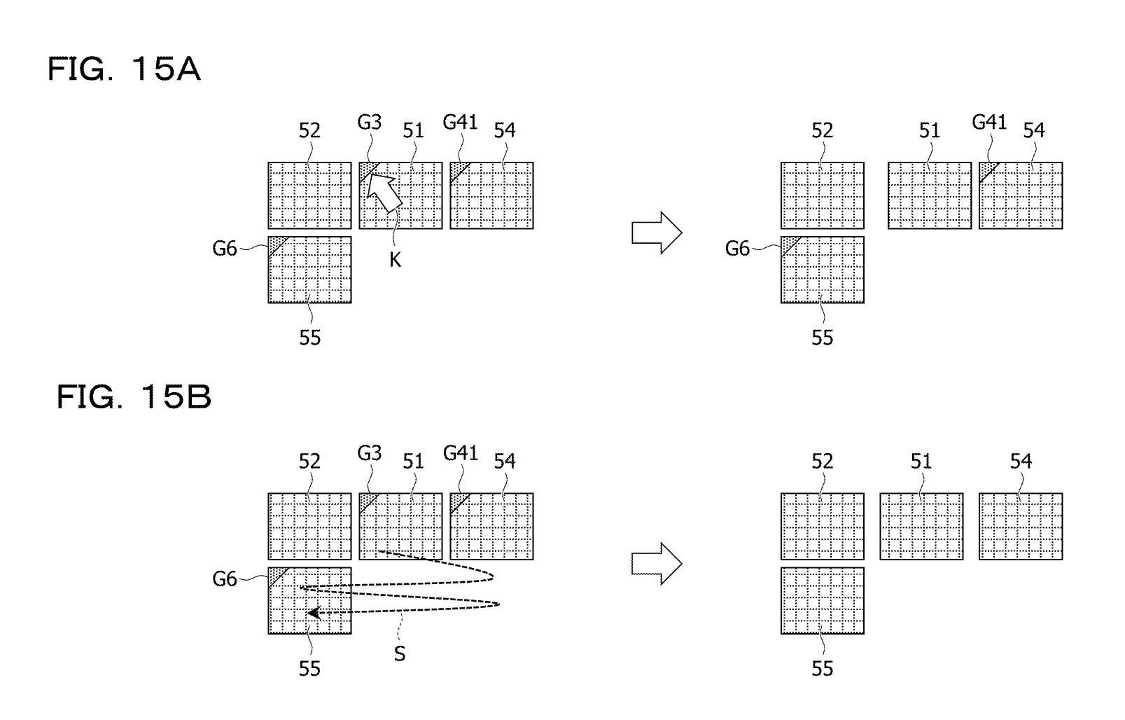

Next, the ungrouping is described with reference to FIGS. 15A and 15B. FIGS. 15A and 15B are diagrams to explain ungrouping of objects of the second embodiment.

FIG. 15A illustrates an example of ungrouping some objects out of multiple objects that are grouped together while FIG. 15B illustrates an example of ungrouping all the objects.

In the example of FIG. 15A, the object 51, the object 52, an object 54, and an object 55 are put into one group. In this instance, the guide G3 associated with the object 52 is superimposed and displayed on the object 51. Meanwhile, the guide G6 associated with the object 52 is superimposed and displayed on the object 55, and a guide G41 associated with the object 51 is superimposed and displayed on the object 54.

When an operation to select the guide G3 is accepted in this state, the grouping control unit 210A ungroups the object 51 and the object 52 that have been grouped together by using the guide G3.

As a consequence, the object 51 and the object 52 no longer belong to the same group in this case. Accordingly, the object 52 and the object 55 are put into one group while the object 51 and the object 54 are put into another group.

Upon acceptance of an operation to rock the entire group including the object 51, the object 52, the object 54, and the object 55 either right and left or up and down as illustrated in FIG. 15B, the grouping control unit 210A ungroups these objects. To put it another way, the grouping control unit 210A ungroups the objects when the grouping control unit 210A accepts an operation to rock the entire group for a distance of a predetermined breadth or more.

For instance, the grouping control unit 210A ungroups all the objects in the case where the operation (a gesture) extends across all of the object 51, the object 52, the object 54, and the object 55 and intends to move the entire group including these objects right and left.

Upon acceptance of the operation to ungroup all the objects, the grouping control unit 210A hides the guides displayed on the objects 51, 54, and 55, thus allowing the user to visually confirm the ungrouping.

As described above, according to this embodiment, it is possible to ungroup some of the grouped objects or to ungroup all the objects in response to the operation on the shared screen.

As a consequence, according to this embodiment, it is possible to change the objects to be included in the group.

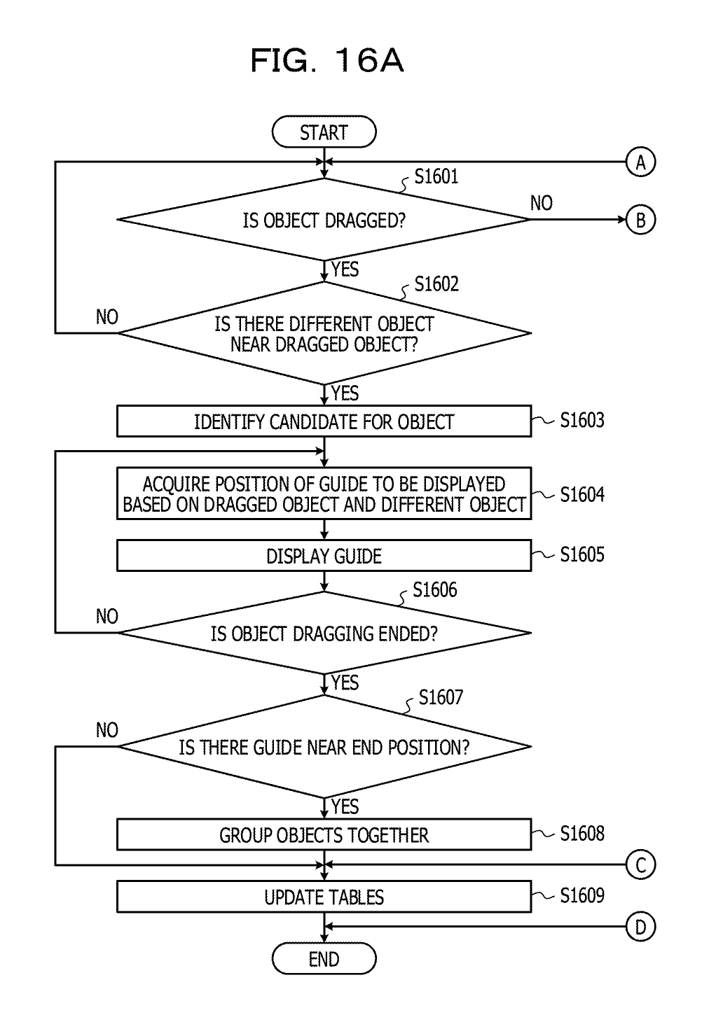

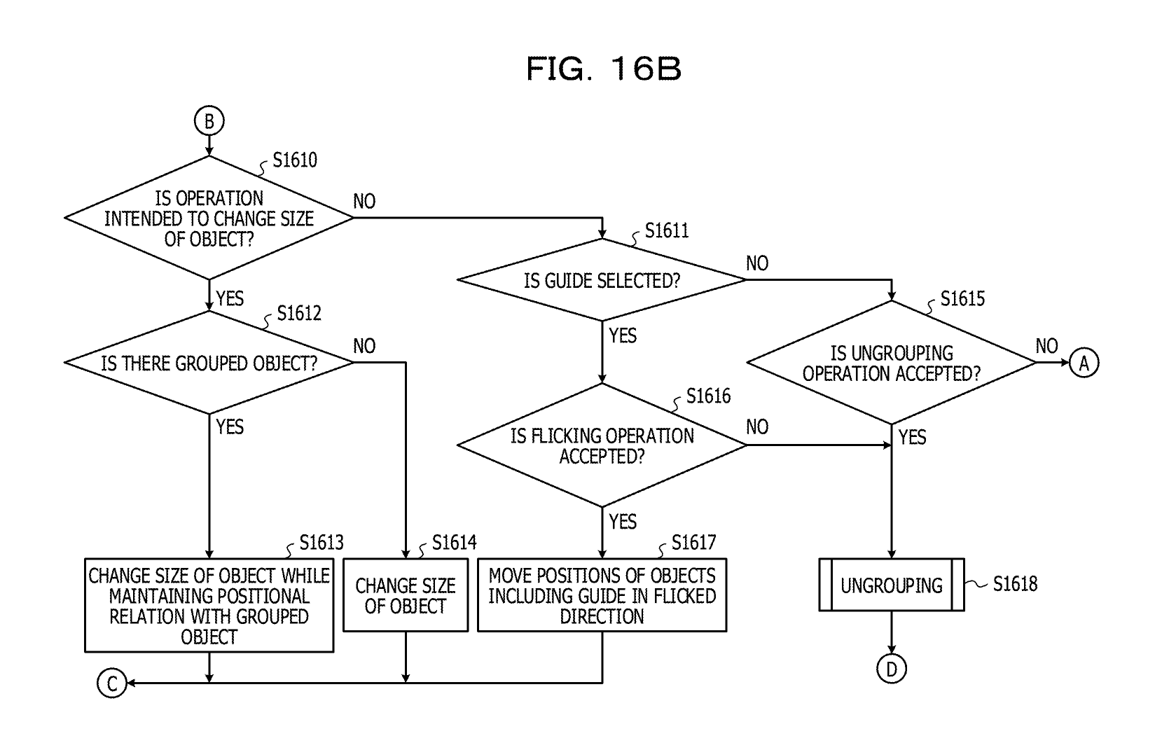

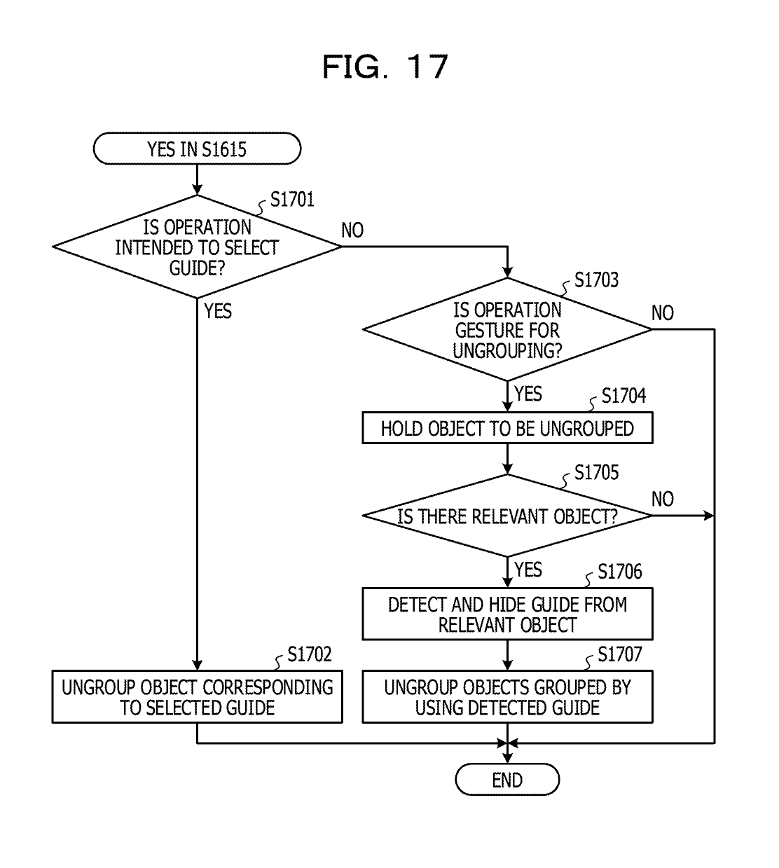

Next, processing by the grouping control unit 210A of this embodiment is described with reference to FIGS. 16 and 17.

FIG. 16 is a first flowchart to explain processing by the grouping control unit of the second embodiment.

The processing from steps S1601 to S1609 in FIG. 16 is the same as the processing from steps S901 to S909 in FIG. 9 and explanations thereof are omitted.

When there is not the applicable object in step S1601, the grouping control unit 210A determines whether or not the operation to change the size of one of the objects is accepted (step S1610).

The grouping control unit 210A proceeds to step S1611 when the relevant operation is not accepted in step S1610.

When the relevant operation is accepted, the grouping control unit 210A causes the display control module 217A to determine whether or not there is the object grouped with the object for which the operation is accepted (step S1612). For instance, the display control module 217A refers to the group information table 222 and determines whether or not there is the group information including the object ID of the object for which the operation is accepted.

When there is the applicable group information in step S1612, the display control module 217A changes the size of the object in response to the operation while maintaining the positional relation with the grouped object (step S1613), and the grouping control unit 210A proceeds to step S1609. The method of changing the size of the object has been described with reference to FIG. 13

In this instance, the object management module 218 may update the value of the item “position” and the value of the item “size” in step S1609, which are included in the object information on the object subjected to the change in size stored in the object information table 221.

When there is not the applicable group information in step S1612, the display control module 217A changes the size of the object according to the operation (step S1614), and the grouping control unit 210A proceeds to step S1609.

In this case, the object management module 218 may update the value of the item “size” included in the object information on the object subjected to the change in size stored in the object information table 221.

When the operation to change the size of the object is not accepted in step S1610, the grouping control unit 210A determines whether or not an operation to select the guide is accepted (step S1611). When the relevant operation is not accepted in step S1611, the grouping control unit 210A proceeds to step S1615.

When the relevant operation is accepted in step S1611, the grouping control unit 210A causes the display control module 217A to determine whether or not the flicking operation is accepted (step S1616). When the relevant operation is not accepted in step S1616, the grouping control unit 210A proceeds to step S1618 to be described later.

When the relevant operation is accepted in step S1616, the grouping control unit 210A causes the display control module 217A to move the display positions of the guide as well as the object on which the guide is superimposed in the flicked direction (step S1617), and proceeds to step S1609.

In this case, the object management module 218 may update the position of the object information in the object information table 221 and the item “guide position” included in the group information in the group information table 222.

When the operation to select the guide is not accepted in step S1611, the grouping control unit 210A causes the ungrouping module 219 to determine whether or not the ungrouping operation is accepted (step S1615).

When the ungrouping operation is not accepted in step S1615, the grouping control unit 210A returns to step S1601.

When the ungrouping operation is accepted in step S1615, the grouping control unit 210A causes the ungrouping module 219 to conduct the ungrouping (step S1618), and terminates the processing.

FIG. 17 is a second flowchart to explain the processing by the grouping control unit of the second embodiment. FIG. 17 illustrates the processing by the ungrouping module 219 in step S1618.

The ungrouping module 219 determines whether or not the accepted operation is the operation to select the guide (step S1701). When the accepted operation is the relevant operation in step S1701, the ungrouping module 219 ungroups the object corresponding to the selected guide (step S1702), and terminates the processing.

For example, the grouping control unit 210A causes the display control module 217A to hide the selected guide, and causes the ungrouping module 219 to delete the group information in the group information table 222 including the object ID of the object on which the guide is superimposed.

When the accepted operation is not the relevant operation in step S1701, the grouping control unit 210A determines whether or not the accepted operation is the operation to entirely ungroup the objects (step S1703).

The processing is terminated when the accepted operation is not the relevant operation in step S1703. When the accepted operation is the relevant operation in step S1703, the ungrouping module 219 holds the object ID of the object designated by the accepted operation (step S1704).

Subsequently, the ungrouping module 219 refers to the group information table 222 and determines whether or not there is the object ID associated with the held object ID (step S1705). To put it another way, the ungrouping module 219 determines whether or not there is the object grouped with the object designated by the accepted operation.

The grouping control unit 210A terminates the processing when there is not the relevant object in step S1705.

When there is the relevant object in step S1705, the ungrouping module 219 detects the guide superimposed and displayed on the relevant object, and causes the display control module 217A to hide the detected guide (step S1706).

Subsequently, the ungrouping module 219 ungroups the objects that have been grouped together by using the detected guide (step S1707), and terminates the processing. For instance, the ungrouping module 219 refers to the group information table 222 and deletes the entire group information including the object ID of the object on which the guide detected in step S1706 is superimposed and displayed.

As described above, in this embodiment, it is possible to change the size of the object while maintaining the grouping. In this embodiment, it is also possible to change the display positions of the object and the guide in response to the operation concerning the screen while maintaining the grouping. According to this embodiment, it is also possible to ungroup the desired object out of the grouped objects by selecting the appropriate guide. In addition, according to this embodiment, it is possible to ungroup all the grouped objects by performing the operation (the gesture) in such a way as to move the entire objects that are grouped together.

This embodiment is configured to execute the various processing procedures based on the operations concerning the objects. However, the processing is not limited only to this configuration. In this embodiment, when the shared screen is a screen projected with an image projection device, for example, a gesture of the user may be detected and accepted as an operation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A grouping control method to be executed by a computer, the grouping control method comprising:
based on a positional relation between a first object and a second object, displaying a third object associated with the second object; and
determining whether or not the first object and the second object are to be grouped together based on a degree of approximation between the first object and the third object.

2. The grouping control method according to claim 1, further comprising:
identifying, as the second object, an object being displayed at a position ahead of a movement direction of the first object and having a distance of a first predetermined value or below from the first object.

3. The grouping control method according to claim 1, further comprising:
displaying the third object around the second object and at a position facing the first object in the movement direction; and
grouping the first object and the second object together when a distance between the first object and the third object is a second predetermined value or below.

4. The grouping control method according to claim 1,
wherein the third object is superimposed and displayed on the first object when the first object and the second object are grouped together.

5. A storage medium having stored therein a program for causing a computer to execute a process below, the process comprising:
based on a positional relation between a first object and a second object, displaying a third object associated with the second object; and
determining whether or not the first object and the second object are to be grouped together based on a degree of approximation between the first object and the third object.

6. An information sharing system, comprising:
an information processing device that includes a processor; and
a display device coupled to the processor and configured to display an object associated with an output from the information processing device, wherein
the display device is configured to
display a third object associated with the second object based on a positional relation between a first object and a second object, and
the processor is configured to
determine whether or not the first object and the second object are to be grouped together based on a degree of approximation between the first object and the third object.

7. The information sharing system according to claim 6,
wherein the processor is configured to identify, as the second object, an object being displayed at a position ahead of a movement direction of the first object and having a distance of a first predetermined value or below from the first object.

8. The information sharing system according to claim 6, wherein
the display device is configured to display the third object around the second object and at a position facing the first object in the movement direction; and
the processor is configured to group the first object and the second object together when a distance between the first object and the third object is a second predetermined value or below.

9. The information sharing system according to claim 8,
wherein the third object is superimposed and displayed on the first object when the first object and the second object are grouped together.
